(19) United States
(12) Patent Application Publication
(10) Pub. No.: US 2009/0284488 A1
(43) Pub. Date: Nov. 19, 2009

(54) ELECTRONIC DEVICE AND METHOD FOR HANDWRITTEN INPUTS

(75) Inventor: KIM-YEUNG SIP, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/465,624

(22) Filed: May 13, 2009

(30) Foreign Application Priority Data
May 16, 2008 (CN) 200810301610.X

(51) Int. Cl. G06F 3/041; G06F 3/048

(52) U.S. Cl. 345/173; 715/843; 382/189

(57) ABSTRACT

An electronic device includes a multi-touch sensitive display. The multi-touch sensitive display displays a graphical user interface having a handwritten region and a menu selection region. The handwritten region receives handwritten inputs. The menu selection region operatively simultaneously provides a menu for switching input types during the handwritten inputs being received.

### BACKGROUND

1. Technical Field

The present disclosure generally relates to handwriting recognition, and particularly to an electronic device and a method for switching input types of handwritten inputs.

2. Description of Related Art

Touch-activated devices, such as touch screens, are combined input/output devices allowing input of data and/or instructions and outputting information as a result of the input. A touch screen generally includes a display screen and a touch sensitive screen. The touch sensitive screen receives touch inputs from a user's finger or a stylus. In response to the touch inputs, the display screen may display characters corresponding to the touch inputs.

In a touch-based input system, users may switch between multiple input types. For example, the users may be writing in English using a stylus, then switch to Chinese to write a word, and then switch back to English. These changes between input types can become cumbersome and distracting to users when the users' concentration is directed to the creation of the handwriting, rather than the steps required to switch between input types. Therefore, an improved electronic device and a method are needed to permit easy switching between input types.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an electronic device for handwritten inputs in accordance with an exemplary embodiment.

FIG. 2 is a graphical user interface configured in a first input type in accordance with the exemplary embodiment.

FIG. 3 is a graphical user interface configured with a pop-up menu for selecting a second input type in accordance with the exemplary embodiment.

FIG. 4 is a graphical user interface configured in the second input type in accordance with the exemplary embodiment.

FIG. 5 is a flowchart of a method for switching multiple input types in accordance with an exemplary embodiment.

### DETAILED DESCRIPTION

In general, the present disclosure provides an electronic device and a method for recognizing handwritten inputs received by a multi-touch sensitive display. A new and useful feature is that the handwritten inputs can be maintained substantially uninterrupted even if multiple input types need to be switched. More detail will be described hereinafter.

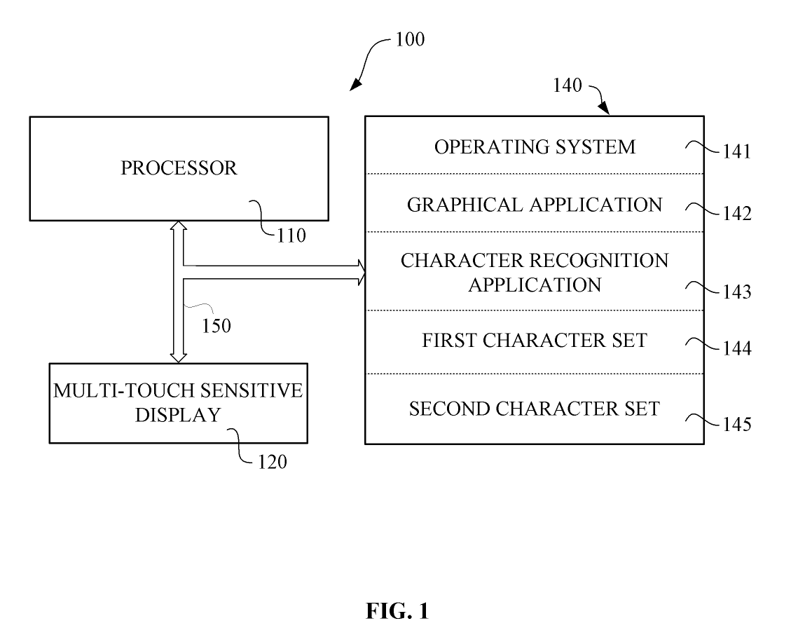

Referring to FIG. 1, a block diagram of an electronic device 100 in accordance with an exemplary embodiment is shown. The electronic device 100 generally includes a processor 110, a multi-touch sensitive display 120, and a storage device 140, all interconnected by a bus 150.

The processor 110 operatively executes/runs various software components stored in the storage device 140 to perform various functions for the electronic device 100, and controls the operations of the electronic device 100.

The multi-touch sensitive display 120 is operable to accept multiple touch inputs from one or more touch objects, for example, a stylus and/or a user' finger. The multi-touch sensitive display 120 may receive/detect the touch inputs using any of a plurality of touch sensitivity technologies, including but not limited to capacitive, resistive, infrared, and surface acoustic wave technologies. The multi-touch sensitive display 120 is also operable to display visual output to the user. The visual output may include text, graphics, video, and any combination thereof. The multi-touch sensitive display 120 may use liquid crystal display (LCD) technology, or light emitting polymer (LPD) display technology, although other display technologies may be used in other embodiments.

The storage device 140 includes one or more types of memory including such as read only memory (ROM) and random access memory (RAM). The storage device 140 may store an operating system 141, a graphical application 142, a character recognition application 143, a first character set 144, and a second character set 145.

The operating system 141 (e.g., LINUX®, UNIX®, WINDOWS®, or an embedded operating system such as VxWorks®) includes various procedures, sets of instructions, software components and/or drivers for controlling and managing general system tasks (e.g., memory management, storage device control, and power management, etc.) and facilitating communication between various hardware and software components.

The graphical application 142 may be implemented by the processor 110 for displaying graphical user interfaces (GUI) on a display surface of the multi-touch sensitive display 120. The character recognition application 143 may be implemented by the processor 110 for recognizing handwritten inputs on the GUI by the stylus or the finger, and finding characters matching the handwritten inputs from the first character set 144 and/or the second character set 145. For example, the first character set 144 may be configured to store a plurality of characters of a first language, such as an English character set. The second character set 145 may be configured to store a plurality of characters of a second language, such as a simplified Chinese character set. In other embodiments, the first language and the second language may be German, French, Italian, Finnish, Spanish, Japanese, Korean, and Arabic etc.

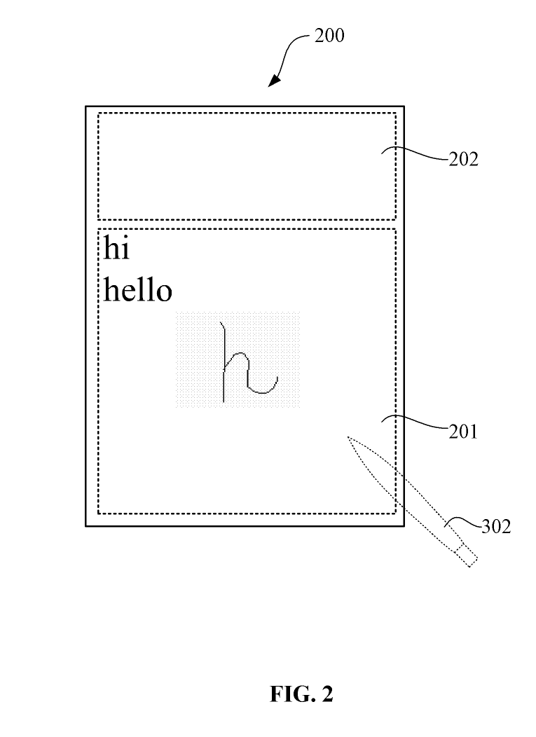

Also referring to FIG. 2, in operation, the processor 110 starts the graphical application 142 to provide a GUI 200. The GUI 200 is displayed by a transparent display surface of the multi-touch sensitive display 120. In the embodiment, the GUI 200 is divided into a handwritten region 201 and a menu selection region 202. The handwritten region 201 is configured to receive handwritten inputs. For example, a user may want to enter a word “Hello” in the handwritten region 201 using the stylus 302. In this case, a character “h” may be handwritten first, which is recognized by the character recognition application 143 as regular character from the first character set 144. Then, the GUI 200 may display a list of words, such as “hi” and “hello” that are mostly related to the character “h” in the handwritten region 201. The word “hello” may be selected and displayed in the handwritten region 201.

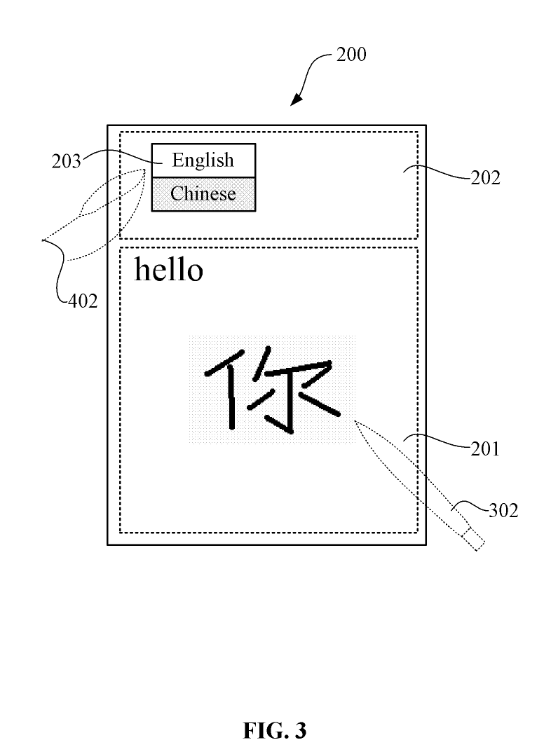

The menu selection region 202 is configured to receive touch inputs, so as to provide a menu having one or more selectable input type options for switching/selecting between different input types. Referring to FIG. 3, after the word “hello” has been entered, a Chinese character may be entered. In this case, the menu selection region 202 is touched to display a pop-up menu 203. The pop-up menu 203 includes at least an English input type option and a simplified Chinese input type option. In order to switch to the simplified Chinese input type, the simplified Chinese input type option is selected. After the simplified Chinese input type option has been selected, the pop-up menu 203 is automatically hidden, that is, not displayed in the menu selection region 202. It should be noted that, in other embodiments, the pop-up menu 203 may be replaced in other form, such as dropdown menu and check box.

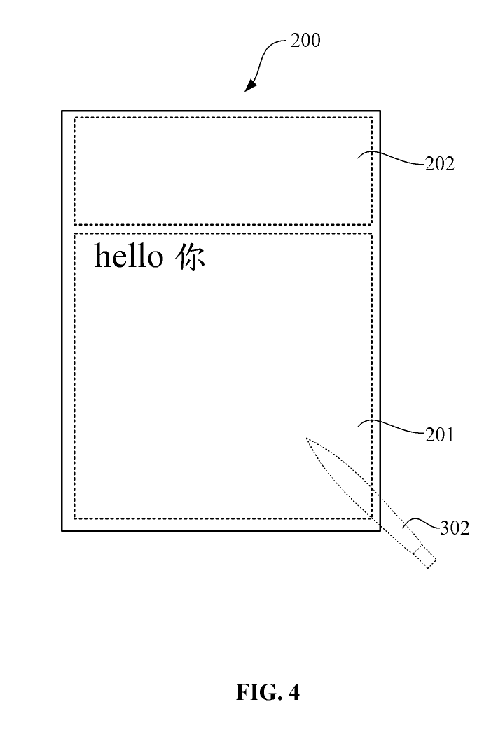

Because the multi-touch sensitive display 120 can receive multiple contacts substantially at the same time, that is, the language can be switched even when the English characters are handwritten or have been recognized. The processor 110 implements the character recognition application 143 to recognize the simplified Chinese character input and display the corresponding character from the simplified Chinese character set in the in the handwritten region 201. For example, referring to FIG. 4, a simplified Chinese character “ [symbol] ” is displayed in the handwritten region 201. Then, the input type is switched back to English by selecting the English input type option in the pop-up menu 203.

As described above, during the user entering characters in the GUI, the languages can be switched much more quickly, such that the handwritten inputs can be maintained substantially uninterrupted even if the language is switched.

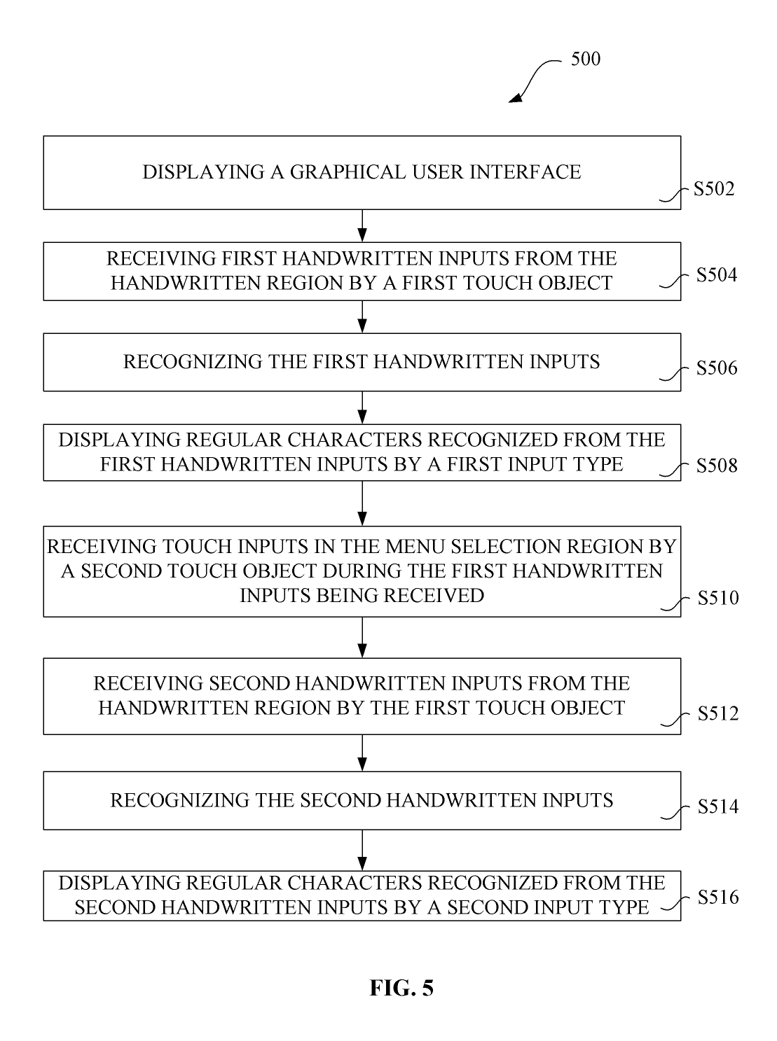

Referring to FIG. 5, a flowchart illustrating a method 500 for switching input types of handwritten recognition is shown. The method 500 includes the following blocks, each of which is tied to various components contained in the electronic device 100 as shown in FIG. 1.

At block S502, the processor 110 of the electronic device 100 implements the graphical application 142 to display a graphical user interface (GUI) 200 on a display surface of a multi-touch sensitive display 120. The GUI 200 is divided into a handwritten region 201 for receiving handwritten inputs, and a menu selection region 202 for providing selectable input type options so as to switch between multiple input types.

At block S504, the multi-touch sensitive display 120 receives first handwritten inputs from the handwritten region 201 by a first touch object, such as a stylus 302. The first handwritten inputs may be done in association with a first input type, such as English.

At block S506, the processor 110 of the electronic device 100 implements the character recognition application 143 to recognize the first handwritten inputs by the first input type. The first handwritten inputs may be a character “h” of a word “hello”, which are recognized by finding characters from a first character set 144.

At block S508, the multi-touch sensitive display 120 displays regular characters recognized from the first handwritten inputs. For example, the regular characters of the word “hello” are displayed by the multi-touch sensitive display 120.

At block S510, the multi-touch sensitive display 120 receives touch inputs from the menu selection region 202 by a second touch object, such as a finger, during the first handwritten inputs being entered from the handwritten region 201. A pop-up menu 203 is displayed in the multi-touch sensitive display 120 in response to the touch inputs in the menu selection region 202. The pop-up menu 203 includes selectable input type options, such as simplified Chinese and English. The simplified Chinese input type option may be selected to switch the input type to simplified Chinese. In response to the selection, a corresponding character set, such as the second character set 145 containing simplified Chinese characters is associated with the handwritten inputs in the handwritten region 201.

At block S512, the multi-touch sensitive display 120 receives second handwritten inputs from the handwritten region 201 by the first touch object, i.e. the stylus 302. The second handwritten inputs may be done in association with a second input type, such as Chinese.

At block S514, the processor 110 of the electronic device 100 implements the character recognition application 143 to recognize the second handwritten inputs by the second input type. The second handwritten inputs may include a simplified Chinese character, which is recognized by finding character matching with the simplified Chinese character from the second character set 145.

At block S516, the multi-touch sensitive display 120 displays regular characters recognized from the second handwritten inputs. For example, the regular character of the simplified Chinese character is displayed by the multi-touch sensitive display 120.

The flowchart in the figures illustrate the architecture, functionality, and operation of possible implementations of electronic devices and methods according to various embodiments of the present invention. In this regard, each step in the flowchart may represent a module, segment, or portion of code, which comprises one or more executable instructions for implementing the specified logical function(s).

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An electronic device, comprising:
a multi-touch sensitive display;
a storage device storing a graphical application and a handwriting recognition application; and
a processor operatively coupled to the multi-touch sensitive display and the storage device, the processor operatively implementing the graphical application from the storage device to cause a graphical user interface to be displayed by the multi-touch sensitive display, the graphical user interface comprising a handwritten region and a menu selection region, the handwritten region operatively receiving handwritten inputs from a first touch object, and the menu selection region operatively providing a menu having at least a first input type option and a second input type option to be selected by a second touch object;
wherein the menu selection region is capable of simultaneously providing the menu for switching to a first input type or a second input type upon selection of the first input type option or the second input type option by the second touch object during the handwritten region receiving the handwritten inputs by the first touch object, the processor operatively implementing the handwriting recognition application from the storage device to recognize the handwritten inputs by the first input type or the second input type, such that the handwritten inputs are substantially uninterrupted by switching actions of the input type.

2. The electronic device according to claim 1, wherein the menu selection region is further capable of automatically hiding the menu upon the input type is switched.

3. The electronic device according to claim 1, wherein the storage device further stores a first character set, and the processor operatively implements the handwriting recognition application from the storage device to recognize the handwritten inputs by selecting characters contained in the first character set upon the first input type is activated.

4. The electronic device according to claim 3, wherein the storage device is further configured to store a second character set, and the processor operatively implements the handwriting recognition application from the storage device to recognize the handwritten inputs by selecting characters contained in the second character set upon the second input type is activated.

5. The electronic device according to claim 1, wherein the menu provided by the menu selection region is any item selected from a group consisting of a pop-up menu, a dropdown menu and a check box.

6. A method for facilitating handwritten inputs using an electronic device having a multi-touch sensitive display, the method comprising:
displaying a graphical user interface by the multi-touch sensitive display, the graphical user interface comprising a handwritten region for receiving handwritten inputs by a first touch object and a menu selection region for providing a menu having selectable input type options for switching between a first input type and a second input type by a second touch object;
receiving handwritten inputs from the handwritten region by the first touch object;
recognizing the handwritten inputs by a first input type;
simultaneously receiving touch inputs from the menu selection region by the second touch object during the handwritten inputs being received from the handwritten region by the first touch object; and
recognizing the handwritten inputs by the second input type when the input type options in the menu are activated to switch the first input type to the second input type.

7. The method according to claim 6, further comprising:
displaying regular characters recognized from the handwritten inputs by the first input type; and
displaying regular characters recognized from the handwritten inputs by the second input type.

8. The method according to claim 6, wherein recognizing the handwritten inputs by the first input type comprises:
recognizing the handwritten inputs by the first input type from characters contained from a first character set.

9. The method according to claim 8, wherein recognizing the handwritten inputs by the second language comprises:
recognizing the handwritten inputs by the second input type from characters contained from a second character set.

10. The method according to claim 6, further comprising:
automatically hiding the menu upon the first input type is switched to the second input type.

11. The method according to claim 6, wherein the menu provided by the menu selection region is any item selected from a group consisting of a pop-up menu, a dropdown menu and a check box.

12. A method for handwritten inputs, comprising:
receiving first handwritten inputs from a handwritten region in a graphical user interface by a first touch object, the graphical user interface being displayed by a multi-touch sensitive display;
recognizing the first handwritten inputs as first regular characters in association with a first input type;
during the first handwriting input being recognized, receiving touch inputs from a menu selection region to display a menu comprising selectable input type options in the graphical user interface by a second touch object;
activating the language items in the menu displayed in the menu selection region so as to switch the first input type to a second input type;
receiving second handwritten inputs from the handwritten region in the graphical user interface by the first touch object; and
recognizing the second handwritten inputs as second regular characters in association with the second input type.

13. The method according to claim 12, further comprising:
displaying the first regular characters and the second regular characters in the handwritten region of the graphical user interface.

14. The method according to claim 12, wherein recognizing the first handwritten inputs comprises:
recognizing the first handwritten inputs by finding matching characters from a first character set.

15. The method according to claim 14 wherein recognizing the second handwritten inputs comprises:
recognizing the second handwritten inputs by finding matching characters from a second character set.

16. The method according to claim 12, wherein the menu provided by the menu selection region is any item selected from a group consisting of a pop-up menu, a dropdown menu and a check box.
